(19) United States
(12) Patent Application Publication
(10) Pub. No.: US 2003/0013430 A1
(43) Pub. Date: Jan. 16, 2003

(54) Wireless messaging registration system and method

(75) Inventors: Craig S. Skinner, Snohomish, WA (US); Steven Oliver Elliott, Renton, WA (US); Mindy Chahal, Menlo Park, CA (US)

Correspondence Address: Alistair K. Chan, FOLEY & LARDNER, Firstar Center, 777 East Wisconsin Avenue, Milwaukee, WI, 53202-5367, US

(73) Assignee: Palm, Inc.

(21) Appl. No.: 09/903,132

(22) Filed: Jul. 11, 2001

(51) Int. Cl. H04M 11/10

(52) U.S. Cl. 455/412; 455/574

(57) ABSTRACT

A wireless e-mail messaging system is disclosed. The wireless e-mail messaging system includes a communications network. The wireless e-mail messaging system also includes a portable electronic device including a transceiver configured to establish a wireless link to the communications network. The portable electronic device includes a wake mode in which the wireless link is established and messages may be sent and received by the portable electronic device and a sleep mode in which the wireless link is not established and messages may not be sent and received by the portable electronic device. The portable electronic device includes a program to randomly select a time to transition from the sleep mode to the wake mode during a predetermined time interval.

### BACKGROUND

Handheld computing devices, “palmtops,” “palmhelds,” personal digital assistants (PDAs), or handheld computers typically weigh less than a pound and fit in a pocket. These handhelds generally provide some combination of personal information management, database functions, word processing, and spreadsheets as well as voice memo recording, wireless e-mail, and wireless telephony functions. Because of the small size and portability of handhelds, strict adherence to hardware constraints such as battery hardware constraints must be maintained.

Handheld computing devices that utilize radio frequency (RF) connections for data or voice communications require power for the RF transceiver modules that require substantial signal amplification for transmission and further require transceiver power for reception. Conventionally, handheld computing devices, which include devices having a persistent wireless connection to a communications network for sending and receiving e-mail messages, are configured to conserve power usage by powering down into a “sleep” mode, in which e-mail messages cannot be sent or received. In conventional devices, after the device enters the “sleep” mode, a default, preset, or user set time is used to “awaken” the device, establish a wireless connection to the communications network, and register the device with a messaging server. Because conventional devices are configured with a default time to awaken, e.g. 8:00 a.m., many of the devices attempt to connect to a communications network service provider simultaneously at 8:00 a.m. Because so many devices attempt to connect to the network simultaneously, severe network congestion problems, such as but not limited to unnecessary waiting times to access the network, network service failure, and/or the requirement for numerous connection attempts may occur.

Accordingly, there is a need for a handheld computer and/or portable electronic device in which wireless communications are enabled at a random moments within a preselected time interval. Further, there is a need for a portable electronic device that allows network connections in such a manner that network congestion may be avoided.

The teachings herein below extend to those embodiments that fall within the scope of the appended claims, regardless of whether they accomplish one or more of the above-mentioned needs.

### SUMMARY OF THE INVENTION

An exemplary embodiment relates to a handheld computer. The handheld computer includes a housing, a display supported by the housing, a microprocessor coupled to the display, and a memory coupled to the microprocessor. The handheld computer also includes a radio frequency transceiver coupled to the microprocessor and configured to establish and maintain a wireless link with a communications network for sending and receiving data. Further, the handheld computer includes a program stored in the memory and configured to automatically establish the wireless link with the communications network at a time approximating a predetermined time. The program is configured to select at random a time within a predetermined interval to establish the wireless link, the predetermined interval being at least one of adjacent and around the predetermined time.

Another exemplary embodiment relates to a method of establishing a wireless connection between a portable electronic device and a communications network. The method includes selecting a predetermined time and selecting an interval that is at least one of adjacent and around the predetermined time. The method also includes choosing at random a link time within the interval. Further, the method includes attempting to establish a wireless link with the communications network at the link time.

Yet another exemplary embodiment relates to a wireless e-mail messaging system. The wireless e-mail messaging system includes a communications network. The wireless e-mail messaging system also includes a portable electronic device including a transceiver configured to establish a wireless link to the communications network. The portable electronic device includes a wake mode in which the wireless link is established and messages may be sent and received by the portable electronic device and a sleep mode in which the wireless link is not established and messages may not be sent and received by the handheld computer. The portable electronic devices includes a program to randomly select a time to transition from the sleep mode to the wake mode during a predetermined time interval.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an exemplary front elevation view of a handheld computer;

FIG. 2 is an exemplary block diagram of a wireless messaging system; and

FIG. 3 is an exemplary process diagram depicting steps for connecting a wireless device to a messaging system.

### DETAILED DESCRIPTION OF THE EXEMPLARY EMBODIMENTS

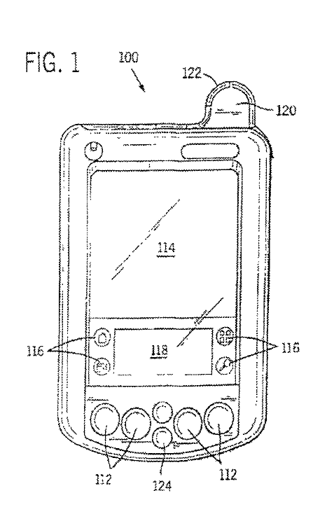

Referring to FIG. 1, a handheld computer 100 is depicted according to an exemplary embodiment. Handheld computer 100 may include Palm style computers manufactured by Palm, Inc., of Santa Clara, Calif. Other exemplary embodiments may include Windows CE handheld computers, or other handheld computers and personal digital assistants, as well as mobile telephones, and other mobile computing devices such as persistent e-mail messaging devices and pagers.

Preferably, handheld computer 100 includes interactive hardware and software that performs functions such as maintaining calendars, phone lists, task lists, note pads, calculator applications, spreadsheets, games, and other applications capable of running on a computing device. Further, handheld computer 100 may be configured for such functions as voice memo recording and playback as well as communications network connectivity, internet connectivity, wireless messaging, e-mail, always-on (persistent) e-mail, and wireless telephony.

Handheld computer 100, depicted in FIG. 1 includes a plurality of input function keys 112 and a display 114 having graphical user interface features. Display 114 may be provided with a touch screen interface that allows a user to select and alter displayed content using a pointer, such as but not limited to a stylus, a pen tip, a fingertip, or other pointing devices.

Referring again to FIG. 1, in an exemplary embodiment, display 114 also includes a Graffiti™ (or other handwriting recognition software) writing section 118 for tracing alpha-numeric characters as input. A plurality of input icons 116 for performing automated or preprogrammed functions may be provided on a portion of display 114.

In an exemplary embodiment, handheld computer 100 may include an integrated antenna 120 configured to transmit and receive wireless communication signals, such as, but not limited to, cellular telephone communication signals, data communications signals, and other radio frequency (RF) communications signals using an RF transceiver. Antenna 120 may further include an indicator light 122 integrated into antenna 120 for indicating the transmission and reception of wireless communication signals. Further, light 122 may be used to indicate other states of handheld computer 100.

In an exemplary embodiment, handheld computer 100 also includes navigation buttons 124 that may be utilized for navigating or scrolling of information displayed on display 114. Further, navigation buttons 124 may be programmed for other uses depending on the application running on handheld computer 100. Handheld computer 100 may be used for any of a variety of wireless communications, including, but not limited to, communications with the World Wide Web, mobile telephone communications, e-mail communications, etc.

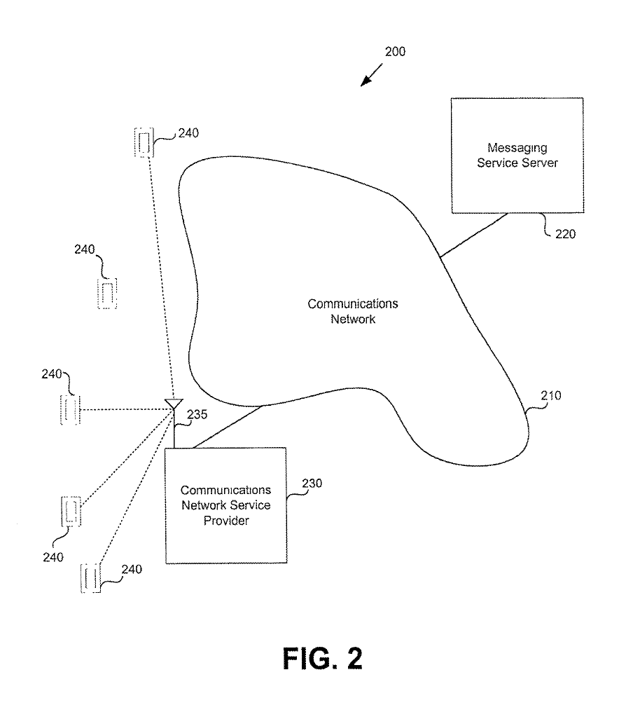

Referring now to FIG. 2, a wireless messaging system 200 is depicted. Wireless messaging system 200 includes a communications network 210, such as but not limited to the internet, and/or other data enabled networks. A messaging service server 220 is coupled to communications network 210. Messaging service server 220 is configured to coordinate messaging services to a plurality of users. Messaging service server 220 includes, but is not limited to an e-mail messaging server. A communications network service provider 230 (or carrier network) is coupled to communications network 210. Communications network service provider 230 provides wireless access to communications network 210. Communications network service provider 230 maintains one or more transmitting/receiving antennas 235 to receive communications signals that are to be sent over communications network 210 and to transmit communications signals to a plurality of handheld and/or portable device 240. Accordingly, antenna network 235 (or antenna array) maintains communications between a plurality of portable devices 240 which are in communications with communications network service provider 230 via antenna network 235. Portable devices 240 include, but are not limited to handheld computers, personal digital assistants (PDAs), cellular telephones, e-mail messaging devices, and the like. Portable electronic devices 240 include transceivers, such as but not limited to radio frequency (RF) transceivers for providing wireless communications with communications network service provider 230.

In operation portable devices 240 are on and connected to or in communications with communications network service provider 230 over a prolonged period of time such that any incoming e-mail or other types of messages addressed for any of portable devices 240 are forwarded to the address specified portable device 240 as soon as it is processed by messaging server 220 and communicated over network 210 to communications network service provider 230. Further, any outgoing e-mails from portable device 240 are immediately sent to communications network service provider 230 over communications network 210 through messaging service server 220 and to the appropriate destination.

In an exemplary embodiment, portable devices 240 include a rechargeable battery or power source configured to provide power for the portable device itself including transmissions and receptions by the portable device. In an exemplary embodiment, the transceiver may utilize a large portion of the battery power. Accordingly, it is beneficial to provide a power down time (“sleep” mode) during a period in which it is unlikely that important messages need to be received by a user of portable device 240. Therefore, a manufacturer may choose a default time in which to transition portable device 240 from the “sleep” mode to a “wake” mode. In the “sleep” mode, device 240 is not enabled to send and receive messages over communications network 240 through the wireless link. In the “wake” mode, device 240 is configured to receive messages continuously and send messages whenever desired.

When transitioned from the “sleep” mode to the “wake” mode, a wireless connection from device 240 to network service provider 230 is made and an attempt to register device 240 with messaging service server 220 is also made. If there are an overabundance of connections attempted to be made at a single time by many devices 240, many problems with communications network service provider 230 may be encountered. Further, if an overabundance of simultaneous registrations are required, similar problems with messaging service server 220 may occur as well. Therefore, it is advantageous to provide an interval of time in which any of devices 240 may be connecting to network service provider 230 at randomly chosen times within that time interval. In an exemplary embodiment, a default time in which the devices 240 automatically transitions from the “sleep” mode to the “wake” mode may be preset by the manufacturer, for example at 8:00 a.m. If all devices 240 in communication with communications network service provider 230 all try to transition at precisely 8:00 a.m. and subsequently try to register with messaging service server 220 all simultaneously, problems with communications network service provider 230 (or messaging service server 220) may be encountered, such as, but not limited to disconnection from communications network service provider 230, disablement of communications network service provider 230, and delays with communications over communications network 210 as well as similar problems with messaging service server 220.

In an exemplary embodiment, portable device 240 includes a computer program (or logic) in which a time interval such as five minutes is predetermined and possibly preset by the manufacturer of portable device 240. A time interval may range anywhere from an hour to several seconds; however, it may be useful to use a time interval such as 300 seconds (or five minutes). Each of the programs of portable devices 240 is configured to randomly choose a single time slot within the 300 -second time interval in which to attempt connection to communications network service provider 230. Therefore, in an exemplary embodiment, at five minutes to 8:00 a.m., portable devices 240 randomly begin transitioning from the “sleep” mode to the “wake” mode and attempt establishing connection to communications network service provider 230. Because of the generation of random connection times, network service provider 230 will not experience congestion and problems associated with congestion will be avoided because portable devices 240 will be connecting to network service provider 230 to register with messaging service server 220 at different randomly chosen times instead of simultaneously. In an alternative exemplary embodiment, other methods besides random choice may be used to distribute connection times within the time interval. For example, a heuristic approach may be used in which connection time is chosen dependent on the amount of activity the day before, or based on the device serial number or address, or any other of a variety of ways.

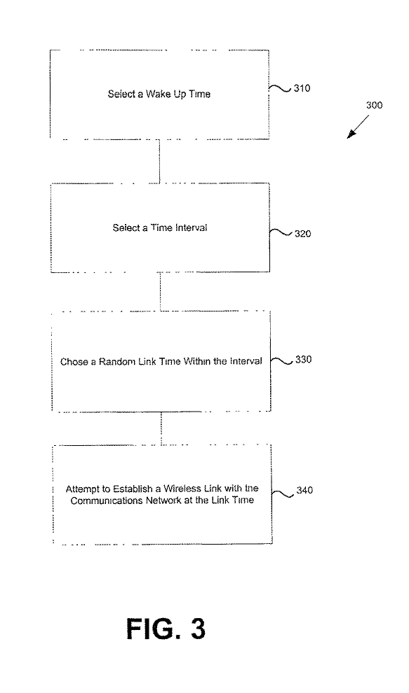

Referring now to FIG. 3, a process 300 depicts the transitioning from “sleep” mode to “wake” mode for a single handheld computer. A wakeup time must be first selected or preset (step 310) such as, but not limited to 8:00 a.m. but preferably in the range of 6:00 a.m. to 9:00 a.m., however, any of a variety of other times may be set by the user. Further, a time interval during which the actual wakeup time is selected should be preset by the manufacturer or selected by an individual user. The time interval may preferably be 300 seconds, but may be any of a variety of appropriate time interval lengths. The time interval may begin prior to the predetermined wake up time, for example a five minute time interval may begin at five minutes to 8:00 a.m. Alternatively, the time interval could be chosen to begin at different times, for example at 2.5 minutes to 8:00 a.m. or at 8 a.m. A program running on portable device 240 chooses a random link time within the time interval (step 330). The random link time is chosen by a random number generator (or any other method) and associated logic to select a link time within the time interval to connect to communications network service provider 230. An attempt to establish a wireless link with the communications network at the randomly generated link time (step 340) may then be accomplished and thereby avoid congestion within communications network service provider 230.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and method depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A handheld computer, comprising:
a housing;
a display supported by the housing;
a microprocessor coupled to the display;
a memory coupled to the microprocessor;
a radio frequency transceiver coupled to the microprocessor and configured to establish and maintain a wireless link with a communications network for sending and receiving data; and
a program stored in the memory and configured to automatically establish the wireless link with the communications network at a time approximating a predetermined time, the program configured to select at random a time within a predetermined interval to establish the wireless link, the predetermined interval being at least one of adjacent and around the predetermined time.

2. The handheld computer of claim 1, wherein the predetermined interval is a 30 minute interval.

3. The handheld computer of claim 1, wherein the predetermined interval is a 10 minute interval.

4. The handheld computer of claim 1, wherein the predetermined interval is a 5 minute interval.

5. The handheld computer of claim 1, wherein the predetermined time is a default time.

6. The handheld computer of claim 1, wherein the default time is in the range of 6:00 a.m. to 9:00 a.m.

7. The handheld computer of claim 1, wherein the default time is 8:00 a.m.

8. The handheld computer of claim 1, wherein the program is configured to cause registration with a messaging service provider server when the wireless link is established.

9. A method of establishing a wireless connection between a portable electronic device and a communications network, comprising:
selecting a predetermined time;
selecting an interval that is at least one of adjacent and around the predetermined time;
choosing at random a link time within the interval;
attempting to establish a wireless link with the communications network at the link time.

10. The method of claim 9, further comprising:
registering with a messaging service provider server.

11. The method of claim 9, wherein the wireless link is used for providing an e-mail messaging service.

12. The method of claim 9, wherein the wireless link is a radio frequency (RF) communications link.

13. The method of claim 9, wherein the interval is in the range of one (1) minute to thirty (30) minutes.

14. The method of claim 9, wherein the predetermined time is in the range of 6:00 a.m. and 9:00 a.m.

15. The method of claim 9, wherein the predetermined time is a default time.

16. The method of claim 15, wherein the default time is 8:00 a.m.

17. A wireless e-mail messaging system, comprising:
a communications network; and
a portable electronic device including a transceiver configured to establish a wireless link to the communications network, the portable electronic device including a wake mode in which the wireless link is established and messages may be sent and received by the portable electronic device and a sleep mode in which the wireless link is not established and messages may not be sent and received by the portable electronic device, the portable electronic device including a program to randomly select a time to transition from the sleep mode to the wake mode during a predetermined time interval.

18. The system of claim 17, wherein the predetermined time interval is a 30 minute interval.

19. The system of claim 17, wherein the predetermined time interval is a 10 minute interval.

20. The system of claim 17, wherein the predetermined time interval is a 5 minute interval.

21. The system of claim 17, wherein the predetermined time interval is a default time interval.

22. The system of claim 17, wherein the default time interval occurs in the range of 6:00 a.m. to 9:00 a.m.

23. The system of claim 17, wherein the default time interval occurs at about 8:00 a.m.

24. The system of claim 17, wherein the program is configured to cause registration with a messaging service provider server when the wireless link is established.

25. The system of claim 17, wherein the portable electronic device is a handheld computer.
